(19) United States
(12) Patent Application Publication
(10) Pub. No.: US 2022/0169241 A1
(43) Pub. Date: Jun. 2, 2022

(54) PARKING ASSIST DEVICE

(71) Applicant: DENSO CORPORATION, Kariya-city (JP)

(72) Inventor: Takamasa HIDAKA, Kariya-city (JP)

(21) Appl. No.: 17/674,340

(22) Filed: Feb. 17, 2022

Related U.S. Application Data
(63) Continuation of application No. PCT/JP2020/030699, filed on Aug. 12, 2020.

(30) Foreign Application Priority Data
Aug. 27, 2019 (JP) 2019-154562

(51) Int. Cl. B60W 30/06; G08G 1/14; G08G 1/00; G06V 40/10; G06V 20/52; H04N 5/235; H04W 4/12; H04W 4/02

(52) U.S. Cl. CPC B60W 30/06; G08G 1/144; G08G 1/146; G08G 1/202; H04W 4/025; G06V 20/52; H04N 5/2353; H04W 4/12; G06V 40/10

(57) ABSTRACT

A parking assist device includes: an exit guidance unit that guides, to a boarding area as a first target position in a parking lot, a self-driving vehicle; a boarding sensing unit that senses an intention of a user to board the self-driving vehicle; an entrance guidance unit that guides the self-driving vehicle to a parking positon as a second target position in the parking lot when a predetermined threshold time period has elapsed without sensing the intention of the user to board by the boarding sensing unit after the self-driving vehicle operated by the exit guidance unit arrived at the boarding area; and a time period determination unit that determines whether a current time is within a predetermined congestion time period that is set as a time period during which the boarding area tends to be congested.

### CROSS REFERENCE TO RELATED APPLICATIONS

This application is a continuation application of International Patent Application No. PCT/JP2020/030699 filed on Aug. 12, 2020, which designated the U.S. and claims the benefit of priority from Japanese Patent Application No. 2019-154562 filed on Aug. 27, 2019. The entire disclosure of all of the above application is incorporated herein by reference.

### TECHNICAL FIELD

The present disclosure relates to a parking assist device configured to assist a user for parking of a vehicle.

### BACKGROUND

As ones of the parking assist devices, technologies for guiding a self-driving vehicle in a parking lot are known. For example, when a user manipulates a terminal device installed in a parking lot, a self-driving vehicle is controlled to exit, that is, the self-driving vehicle is moved from a parking position in the parking area where the self-driving vehicle has been parked to a boarding area where the user boards the self-driving vehicle.

### SUMMARY

According to one aspect of the present disclosure, a parking assist device is configured to assist a user to park a self-driving vehicle. The parking assist device includes: an exit guidance unit that is configured to guide, to a boarding area as a first target position in a parking lot, the self-driving vehicle capable of performing self-driving based on a user's intention to exit; a boarding sensing unit that is configured to sense an intention of the user to board the self-driving vehicle; an entrance guidance unit that is configured to guide the self-driving vehicle to a parking positon as a second target position in the parking lot when a predetermined threshold time period has elapsed without sensing the intention of the user to board by the boarding sensing unit after the self-driving vehicle operated by the exit guidance unit arrived at the boarding area; and a time period determination unit that is configured to determine whether a current time is within a predetermined congestion time period that is set as a time period during which the boarding area tends to be congested. The entrance guidance unit is further configured not to guide the self-driving vehicle to the second target position when the time period determination unit determines that the current time is not within the congestion time period.

### BRIEF DESCRIPTION OF DRAWINGS

FIG. 1 is a plan view of a parking lot.

FIG. 2 is a block diagram illustrating the configuration of a parking assistance system.

FIG. 3 is a diagram of functional blocks in a control unit of a management device.

FIG. 4 is a flowchart of an exit setting process executed by the management device.

FIG. 5 is a flowchart of a self-driving exit process executed by a self-driving vehicle.

FIG. 6 is a content to be displayed when a self-driving vehicle arrives at an exit room area.

FIG. 7 is a flowchart of a content determination process executed by the management device.

FIG. 8 is a content to be displayed if a user is sensed.

FIG. 9A is a content to be displayed if a user is not sensed, and also a timer can be extended.

FIG. 9B is a content to be displayed if a user is not sensed, and also a timer cannot be extended.

### DESCRIPTION OF EMBODIMENTS

To begin with, a relevant technology will be described first only for understanding the following embodiments.

As a result of thorough examination by the inventors, it has been found that there is a problem in a conventional parking assist system described above If boarding by the user is delayed after the self-driving vehicle has been moved to the boarding area, the boarding area is occupied by the self-driving vehicle waiting for the user, which hinders another vehicle exiting the parking area. Simply limiting the period during which the self-driving vehicle can be stopped in the boarding area would impair the convenience of the user in some cases.

In view of the above, one aspect of the present disclosure is to provide a parking assist device where convenience of the user is not impaired while avoiding a situation where the self-driving vehicle waiting for the user would not inhibit other vehicles from exiting.

As described above, according to the one aspect of the present disclosure, a parking assist device is configured to assist a user to park a self-driving vehicle. The parking assist device includes: an exit guidance unit that is configured to guide, to a boarding area as a first target position in a parking lot, the self-driving vehicle capable of performing self-driving based on a user's intention to exit; a boarding sensing unit that is configured to sense an intention of the user to board the self-driving vehicle; an entrance guidance unit that is configured to guide the self-driving vehicle to a parking positon as a second target position in the parking lot when a predetermined threshold time period has elapsed without sensing the intention of the user to board by the boarding sensing unit after the self-driving vehicle operated by the exit guidance unit arrived at the boarding area; and a time period determination unit that is configured to determine whether a current time is within a predetermined congestion time period that is set as a time period during which the boarding area tends to be congested. The entrance guidance unit is further configured not to guide the self-driving vehicle to the second target position when the time period determination unit determines that the current time is not within the congestion time period.

According to another aspect of the present disclosure, a parking assist device is configured to assist a user to park a self-driving vehicle. The parking assist device includes at least one processor that is configured to: guide, to a boarding area as a first target position in a parking lot, the self-driving vehicle capable of performing self-driving based on a user's intention to exit; sense an intention of the user to board the self-driving vehicle; guide the self-driving vehicle to a parking positon as a second target position in the parking lot when a predetermined threshold time period has elapsed without sensing the intention of the user to board after the self-driving vehicle operated by the exit guidance unit arrived at the boarding area; and determine whether a current time is within a predetermined congestion time period that is set as a time period during which the boarding area tends to be congested. The processor is further configured not to guide the self-driving vehicle to the second target position upon determining that the current time is not within the congestion time period.

According to the above-described aspect, because the self-driving vehicle is moved to the parking position when the threshold time period has elapsed after the self-driving vehicle arrived at the boarding area, it is possible to reduce the likelihood that the self-driving vehicle occupies the boarding area for a long time. It is possible to reduce the likelihood that the self-driving vehicle is moved when the user has approached the self-driving vehicle within the threshold time period. Therefore, it is possible to reduce the likelihood that the self-driving vehicle waiting for the user hinders another vehicle exiting a parking area while the convenience of the user is ensured.

Hereinafter, an embodiment of the present disclosure is explained with reference to the figures.

[1-1. Configuration of Parking Assistance System 1]

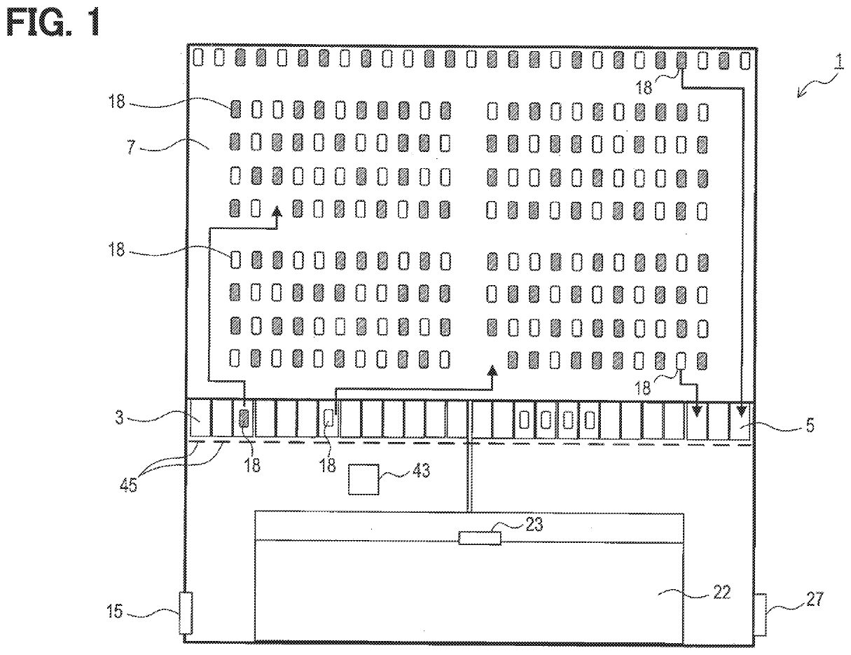

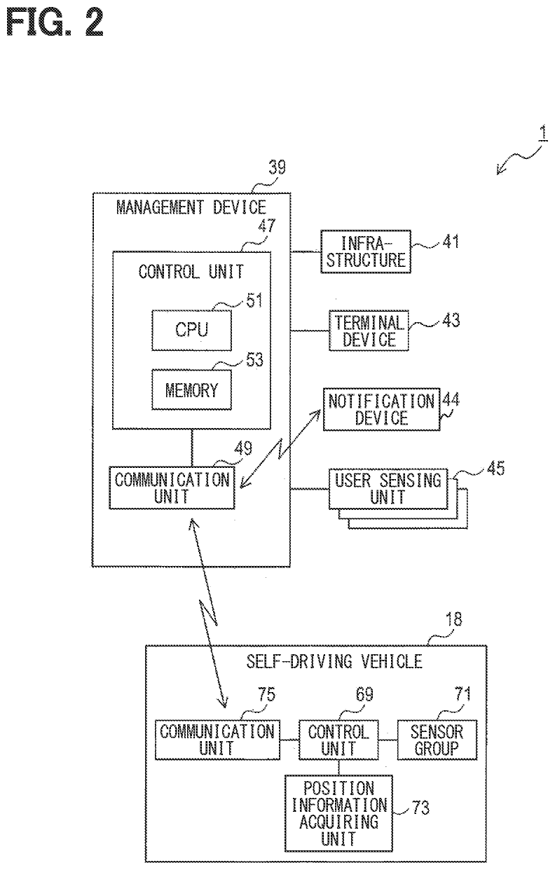

The configuration of a parking assistance system 1 is explained on the basis of FIG. 1 and FIG. 2. As illustrated in FIG. 1, the parking assistance system 1 includes: an entrance room area 3 set as an alighting area where a user alights from a vehicle; an exit room area 5 set as a boarding area where the user boards the vehicle; and a parking lot 7. An area including the entrance room area 3, the exit room area 5, and the parking lot 7 is denoted also as the parking lot below.

A plurality of spaces are provided in each of the entrance room area 3, and the exit room area 5. A plurality of user sensing units 45 are included in the entrance room area 3, and the exit room area 5 as illustrated in FIG. 1, and FIG. 2. A user sensing unit 45 is included in each of the plurality of spaces in the entrance room area 3, and the exit room area 5.

A user sensing unit 45 is a configuration for sensing the intention of a user to board and alight from a self-driving vehicle 18, and is configured as a shutter that opens and closes vertically in the present embodiment, for example. When the shutter is open, it is sensed that the user has the intention to board and alight from the self-driving vehicle 18, and when the shutter is closed, it is sensed that the user does not have the intention to board and alight from the self-driving vehicle 18.

The entrance room area 3 is connected with the outside of the parking assistance system 1 via an entrance 15. Each self-driving vehicle 18 can pass through the entrance 15 from the outside, and enter the entrance room area 3. The self-driving vehicle 18 has a self-driving valet parking functionality.

The self-driving vehicle 18 only has to be capable of implementing the self-driving valet parking functionality in the parking lot, and needs not to have a functionality of performing self-driving outside the parking lot. The self-driving valet parking functionality includes a functionality of travelling, by self-driving, from the entrance room area 3 to a parking position in the parking lot 7, and parking at the parking position, and a functionality of travelling, by self-driving, from the parking position in the parking lot 7 to the exit room area 5.

In particular, the self-driving valet parking functionality includes a functionality of repeatedly acquiring position information about the self-driving vehicle 18, and transmitting the position information to a management device 39 which is equivalent to the parking assist device of the present disclosure, and a functionality of receiving a guidance route from the management device 39, controlling the self-driving vehicle 18, and causing the self-driving vehicle 18 to travel in accordance with the guidance route. The position information about the self-driving vehicle 18 represents a result of an estimation of the current location of the self-driving vehicle 18, and includes coordinate values in the area of the parking lot, for example.

The entrance room area 3, and the exit room area 5 are adjacent to an entrance 23 of a facility 22 such as a store. The user such as an occupant of a self-driving vehicle 18 having entered the entrance room area 3 alights from the self-driving vehicle 18, and can walk to the entrance 23.

The exit room area 5 is connected with the outside of the parking assistance system 1 via an exit 27. The self-driving vehicle 18 passes through the exit 27 from the exit room area 5, and can travel to the outside of the parking assistance system 1. The exit room area 5 is adjacent to the entrance 23. The user can walk to the exit room area 5 from the entrance 23.

The parking lot 7 is a place where a plurality of self-driving vehicles 18 can be parked. The parking lot 7 includes a plurality of parking areas. Each of the plurality of parking areas includes a plurality of spaces.

Each space provided in the entrance room area 3, the exit room area 5, and the parking lot 7 is an area where one self-driving vehicle 18 can be parked. The self-driving vehicles 18 can travel from the entrance room area 3 to the parking lot 7. The self-driving vehicles 18 can travel from the parking lot 7 to the exit room area 5.

As illustrated in FIG. 2, the parking assistance system 1 includes the management device 39, an infrastructure 41, a terminal device 43, a notification device 44, and the plurality of user sensing units 45 mentioned before.

The management device 39 includes a control unit 47, and a communication unit 49. The control unit 47 includes a microcomputer having a CPU 51, and a semiconductor memory (hereinafter, referred to as a memory 53) such as a RAM or a ROM, for example.

Respective functionalities of the control unit 47 are realized by the CPU 51 executing a program stored on a non-transitory tangible recording medium. In this example, the memory 53 is equivalent to the non-transitory tangible recording medium storing the program. By executing the program, a method corresponding to the program is executed. The control unit 47 may include one microcomputer or may include a plurality of microcomputers.

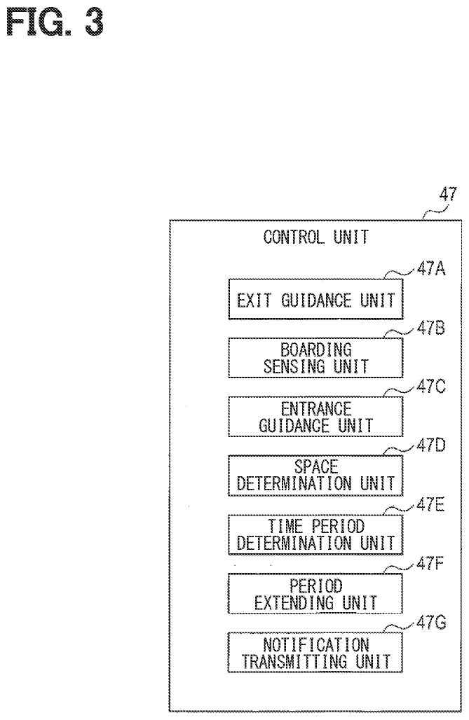

The control unit 47 includes a configuration for transmitting, to a self-driving vehicle 18, a guidance route to a parking position, and an unaided movement start instruction. For example, as illustrated in FIG. 3, the control unit 47 includes an exit guidance unit 47A, a boarding sensing unit 47B, an entrance guidance unit 47C, a space determination unit 47D, a time period determination unit 47E, a period extending unit 47F, and a notification transmitting unit 47G. Operation of the respective units 47A to 47G included in the control unit 47 is mentioned later.

The memory 53 has map information about the parking lot stored thereon. The map information includes information representing the status of each space in the parking lot 7. The status of each space is either a status that the space is available (hereinafter, referred to as the available status) or a status that the space is occupied by a self-driving vehicle 18 (hereinafter, referred to as the occupied status). The communication unit 49 can communicate with self-driving vehicles 18.

The infrastructure 41 includes one which acquires information representing the situation of the inside of the parking assistance system 1 (hereinafter, referred to as parking lot internal situation information), and supplies the parking lot internal situation information to the management device 39. The infrastructure 41 includes cameras that capture images of the inside of the parking assistance system 1, lidars, and the like.

For example, examples of the parking lot internal situation information include information representing the positions of obstacles, information representing the status of each space in the parking lot 7, position information about self-driving vehicles 18 located inside the parking assistance system 1, and the like.

As illustrated in FIG. 1, the terminal device 43 is installed near the entrance room area 3. The terminal device 43 accepts input manipulation by users. The terminal device 43 outputs, to the management device 39, signals according to the input manipulation.

For example, the terminal device 43 outputs an exit request signal or the like in accordance with input manipulation which represents the intention of a user to cause a self-driving vehicle 18 to exit. The exit request signal is a signal requesting to transport a self-driving vehicle 18 parked in the parking lot 7 to the exit room area 5. For example, the terminal device 43 outputs identification information about a self-driving vehicle 18 in accordance with input manipulation. For example, the identification information is information such as a number plate for uniquely specifying a self-driving vehicle 18.

The notification device 44 is configured to be capable of wireless communication with the management device 39, and, by receiving data including the status of a self-driving vehicle 18 from the management device 39, notifies the status of the self-driving vehicle 18 by using an image and a sound. The notification device 44 is configured as a wireless terminal device such as a portable phone or a smartphone carried by a user. The notification device 44 includes a display, and a speaker, for example, that function as notifying units that perform notification to the user. In accordance with a command from the management device 39, the notification device 44 performs notification to the user through the display, and the speaker by using an image and a sound. The display corresponds to an example of a display unit.

The notification device 44 is also configured to be capable of receiving, as input, an instruction from the user related to operation of the self-driving vehicle 18. In the present embodiment, the user can input an extension request mentioned later to the notification device 44. The notification device 44 may receive, as input manipulation, the intention of the user to cause the self-driving vehicle 18 to exit. In accordance with input manipulation by the user, the notification device 44 outputs the exit request signal to the management device 39. The notification device 44 corresponds to an example of a manipulation terminal configured to be capable of receiving a request from the user as input.

As mentioned before, each self-driving vehicle 18 includes the self-driving valet parking functionality. As illustrated in FIG. 2, the self-driving vehicle 18 includes a control unit 69, a sensor group 71, a position information acquiring unit 73, and a communication unit 75. The control unit 69 controls the respective units of the self-driving vehicle 18. The self-driving functionality is realized by the control performed by the control unit 69. The self-driving vehicle 18 acquires, from the management device 39, the map information about the parking lot, and a guidance route, and uses the map information about the parking lot, and the guidance route when performing self-driving.

The sensor group 71 acquires surrounding environment information representing the situation around the self-driving vehicle 18. For example, examples of the content of the surrounding environment information include the positions of obstacles located around the self-driving vehicle 18, and the like. For example, the sensor group 71 includes cameras, lidars, and the like. When performing self-driving, the self-driving vehicle 18 uses the surrounding environment information.

The position information acquiring unit 73 acquires position information about the self-driving vehicle 18. For example, the position information acquiring unit 73 is a position estimation system that uses the lidars and a map. The self-driving vehicle 18 uses the position information when performing self-driving. The communication unit 75 can communicate with the management device 39.

[1-2. Processes]

[1-2-1. Exit Setting Process Executed by Management Device 39]

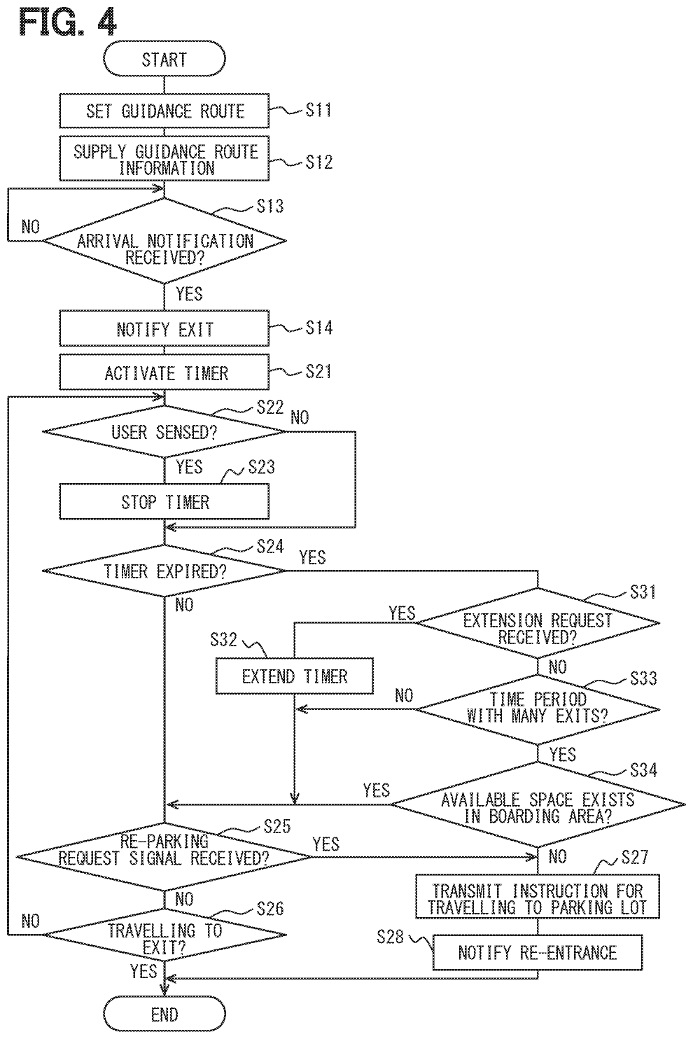

An exit setting process executed by the management device 39 is explained on the basis of FIG. 4. The exit setting process is a process of causing a self-driving vehicle 18 to move from a parking position to the exit room area 5 by unaided movement of the self-driving vehicle 18.

For example, the exit setting process is a process that is started after the management device 39 receives the exit request signal. Here, the exit request signal is a signal representing a request that the self-driving vehicle 18 be moved from the parking position to the exit room area 5, and when a user manipulates the terminal device 43 to input an exit request, the terminal device 43 transmits the exit request signal to the management device 39.

In the exit setting process, first at Step (hereinafter, abbreviated to S) 11, the exit guidance unit 47A of the management device 39 sets a guidance route. At this time, the exit guidance unit 47A chooses a target position. As the target position, a space in the exit room area 5 where no vehicles are stopped, that is, a space in the available status, is chosen. For example, the exit guidance unit 47A determines the status of each space in the following manner. When a self-driving vehicle 18 stops at a space, the self-driving vehicle 18 sends, to the management device 39, identification information about the space, and information about the start of the stop. When the self-driving vehicle 18 leaves the space where the self-driving vehicle 18 has been stopped, the self-driving vehicle 18 sends, to the management device 39, the identification information about the space, and information about the end of the stop.

On the basis of the history of information sent from self-driving vehicles 18, the exit guidance unit 47A determines the status of each space. The exit guidance unit 47A may determine the status of each space on the basis of information supplied by the infrastructure 41.

After setting the target position, the exit guidance unit 47A uses the map information about the parking lot to set a guidance route. Here, the exit guidance unit 47A sets the guidance route to a guidance route for unaided movement of the self-driving vehicle 18, and is a route from the current location of the self-driving vehicle 18 to a space in the exit room area 5 set as the target position.

Subsequently, at S12, by using the communication unit 49, the exit guidance unit 47A transmits information representing the guidance route set at S11 (hereinafter, referred to as guidance route information). That is, the exit guidance unit 47A transmits the guidance route information to the self-driving vehicle 18. After receiving the guidance route information, the self-driving vehicle 18 starts self-driving along the guidance route.

Subsequently, at S13, the exit guidance unit 47A determines whether or not an arrival notification has been received. The arrival notification is a notification transmitted by the self-driving vehicle 18 when the self-driving vehicle 18 has arrived at the target position which is the end point of the guidance route, in this case a space in the exit room area 5. If the arrival notification has not been received, S13 is repeated.

If the arrival notification has been received, at S14, the notification transmitting unit 47G of the management device 39 gives an exit notification to the notification device 44. The exit notification is a signal for notifying the user that the self-driving vehicle 18 has completed an exit to the exit room area 5. After receiving the exit notification, the notification device 44 gives a notification to the user by using an image and a sound according to the exit notification.

Here, the image notified to the user includes an image for prompting the user to input an extension request, and an image for prompting the user to input a re-parking request. If the user selects, on the notification image displayed on the notification device 44, the image for prompting the user to input the extension request or the image for prompting the user to input the re-parking request, the notification device 44 transmits, to the management device 39, an extension request signal or a re-parking request signal mentioned later.

Subsequently, at S21, the boarding sensing unit 47B of the management device 39 activates a timer for measuring a threshold time period. At the time of activation of the timer, the timer is reset once. The threshold time period is a maximum period over which the self-driving vehicle 18 is permitted to stay in the exit room area 5, and is set in advance for each parking lot.

Subsequently, at S22, the boarding sensing unit 47B determines whether or not the user sensing unit 45 has sensed the user in the space of the exit room area 5. In the case of the present embodiment, it is determined whether or not the shutter has been opened. For example, each shutter is opened and closed by a user manipulating an opening/closing switch installed near the shutter. Also if the management device 39 has received a sensing notification mentioned later from the self-driving vehicle 18, the boarding sensing unit 47B determines that the user has been sensed. When the user is sensed by the boarding sensing unit 47B, the boarding sensing unit 47B determines that the user is approaching the self-driving vehicle 18.

If the user has not been sensed, it is considered that the user does not have the intention to board the self-driving vehicle 18, and the present process proceeds to S24. If the user has been sensed at S22, it is considered that the user has the intention to board the self-driving vehicle 18, and, at S23, the boarding sensing unit 47B stops the timer for measuring the threshold time period.

Subsequently, at S24, the boarding sensing unit 47B determines whether or not the timer has expired. The timer is determined as having expired when the threshold time period mentioned before has elapsed. If the timer has expired, the process proceeds to S31.

If the timer has not expired, at S25, the exit guidance unit 47A determines whether or not there is the re-parking request signal. The re-parking request signal is a signal for requesting to have the self-driving vehicle 18 returned to a parking position. The re-parking request signal is a signal output by the terminal device 43 or the notification device 44 to the management device 39 in accordance with input manipulation by the user.

If there is the re-parking request signal, the present process proceeds to S27. If there is not the re-parking request signal, at S26, the exit guidance unit 47A determines whether or not the self-driving vehicle 18 has started travelling from the exit room area 5 toward the exit 27. If the self-driving vehicle 18 is not travelling toward the exit 27, the exit guidance unit 47A returns to S22 of the present process. If the self-driving vehicle 18 is travelling toward the exit 27, the exit guidance unit 47A ends the present process.

Meanwhile, at S31, the period extending unit 47F of the management device 39 determines whether or not there is the extension request signal. The extension request signal is a request that the entrance guidance unit 47C be not operated. The extension request signal is a signal output by the terminal device 43 or the notification device 44 to the management device 39 in accordance with input manipulation by the user.

If there is the extension request signal, at S32, the period extending unit 47F extends the timer for measuring the threshold time period, and proceeds to S25. For example, the extension of the timer is realized by resetting the timer, changing the threshold time period to a larger value, and so on.

Regarding the extension of the timer, the user may manipulate the terminal device 43 or the notification device 44 to set the threshold time period. For example, one extended period or two or more extended periods set in advance in the terminal device 43 or the notification device 44 may be displayed, and the user may be allowed to select one of them. Alternatively, the user may be allowed to input an extended period as desired. By adjusting a period over which the self-driving vehicle 18 waits in the exit room area 5, it can become more suited to an action plan of the user.

The extension or reset of the timer may be limited to a predetermined number of times, for example once. In this case, if the user tries to execute the extension or reset for the second time, the period extending unit 47F may notify that the user is not allowed to extend or reset the timer, and the process may proceed to S33. With such a configuration, if the user of the self-driving vehicle 18 is about to board the self-driving vehicle 18, the user who has arrived at the exit room area 5 can board the self-driving vehicle 18 promptly because the self-driving vehicle 18 is waiting in the exit room area 5. For other users, because the number of times of extension of the timer is limited, it is possible to avoid a situation where the exit room area 5 is occupied for a predetermined period or longer.

If there is not the extension request signal, at S33, the time period determination unit 47E of the management device 39 determines whether or not the current time is in a time period during which there are usually many exits, in other words, in a congestion time period set in advance as a time period during which the boarding area usually becomes congested. Time periods during which there are usually many exits are set as desired for each parking lot. In addition to the congestion time periods, the time period determination unit 47E may have stored thereon time periods other than the congestion time periods as normal time periods. The normal time periods may be all the other time periods than the congestion time periods in the 24 hours. Alternatively, normal time periods may be time periods other than the congestion time periods in the business hours of the facility 22 such as a store.

If the current time is not in a time period during which there are usually many exits, the process proceeds to S25. If the current time is in a normal time period, the time period determination unit 47E keeps the self-driving vehicle 18 parked in the exit room area. If the current time is in a time period during which there are usually many exits, at S34, the space determination unit 47D of the management device 39 determines whether or not there is an available space where there is not a vehicle in a plurality of spaces in the boarding area.

If there is an available space, the present process proceeds to S25. In this case, the self-driving vehicle 18 is kept parked in the exit room area. If there are no available spaces, the process proceeds to S27, and the entrance guidance unit 47C of the management device 39 transmits an instruction for travelling to the parking lot 7.

That is, if the intention is not sensed by the boarding sensing unit 47B within the threshold time period set in advance after the self-driving vehicle 18 arrives at the boarding area due to operation of the exit guidance unit 47A, the entrance guidance unit 47C transmits the instruction for travelling to the parking lot 7. It should be noted however that in the case of any of [a] to [d] described below, it is permitted to extend the threshold time period or the self-driving vehicle 18 is permitted to stay in the exit room area 5 longer than the threshold time period.

[a] If an extension request which is a request that the entrance guidance unit 47C be not operated is received

[b] If the current time is not in a congestion time period

[c] If there is an available space in the exit room area 5

[d] If there is not the re-parking request signal

When the entrance guidance unit 47C transmits the instruction for travelling to the parking lot, similar to S11, a guidance route is set with a parking position in the parking lot 7 as the target position, and the guidance route is transmitted to the self-driving vehicle 18 as the travel instruction. In this process, for example, the entrance guidance unit 47C sets, as the target position, a parking position where the self-driving vehicle 18 had been parked immediately before the self-driving vehicle 18 moved to the exit room area 5. The entrance guidance unit 47C may newly search for a space in the available status in the parking lot 7, and set the space as the target position. The request that the entrance guidance unit 47C be not operated corresponds to a request that the entrance guidance unit 47C be left unoperated.

Subsequently, at S28, the notification transmitting unit 47G gives a re-entrance notification to the notification device 44. The re-entrance notification is a signal for notifying the user that the self-driving vehicle 18 is returned to a parking position, that is, the self-driving vehicle 18 is caused to re-enter. After receiving the re-entrance notification, the notification device 44 gives a notification to the user by using an image and a sound according to the re-entrance notification. After S28, the present process ends.

Here, the notification that the notification transmitting unit 47G of the management device 39 causes the notification device 44 to implement in the process described above is explained. In the following explanation, an aspect in which the notification transmitting unit 47G causes the notification device 44 to display an image is described. The notification transmitting unit 47G may cause the notification device 44 to output a sound. The notification transmitting unit 47G may transmit a text by a short message service (also called a short mail), and cause the notification device 44 to display the text. An image, a text, a sound, a notification sound, and the like output from the display, and the speaker of the notification device 44 in accordance with a command from the notification transmitting unit 47G are examples of contents.

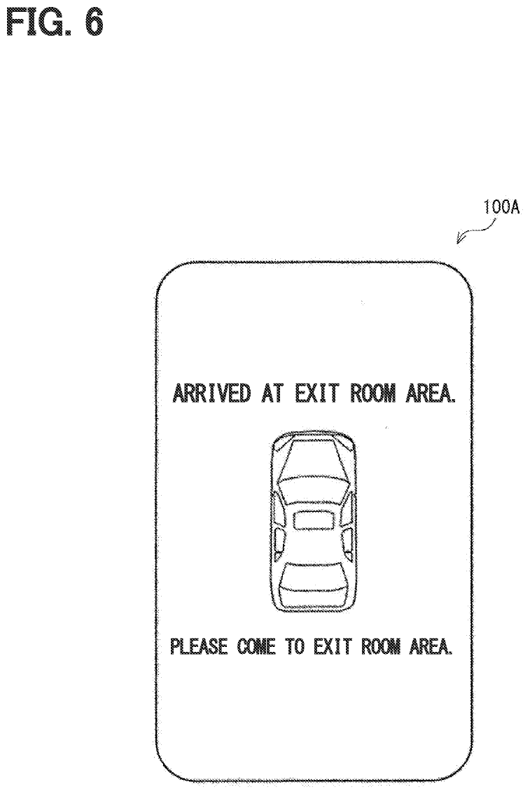

An exit notification image 100A in FIG. 6 is an example of an image accompanying the exit notification at S14, and is an example of the exit notification content. The exit notification image 100A includes a picture of a vehicle, a message representing that the self-driving vehicle 18 has arrived at the exit room area, and a message prompting to head to the exit room area 5. The user who saw the exit notification image 100A intuitively grasps that the self-driving vehicle 18 has arrived at the exit room area 5. Instead of the picture of the vehicle, an image of the self-driving vehicle 18 of the user may be captured by a camera of the infrastructure 41, the image of the self-driving vehicle 18 may be processed, and the processed image may be used. The image may be an image of the self-driving vehicle 18 captured from the front side of the self-driving vehicle 18.

At S22, in accordance with a result of the determination by the boarding sensing unit 47B, the space determination unit 47D, and the time period determination unit 47E, the notification transmitting unit 47G changes an image that the notification device 44 is caused to notify. That is, an image to be displayed on the notification device 44 is changed depending on whether or not the user has been sensed by the boarding sensing unit 47B, and whether or not extension of the timer by the user is possible.

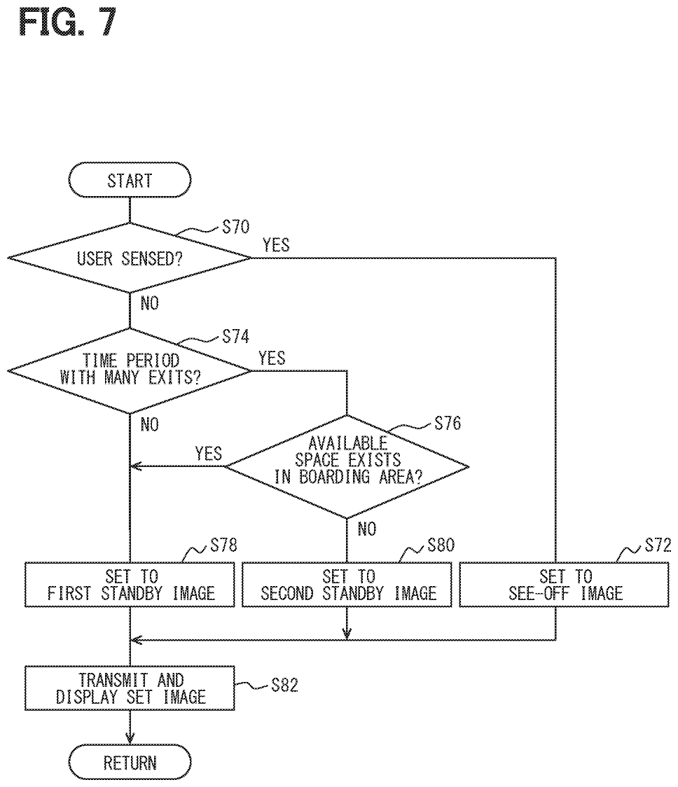

FIG. 7 is a flowchart of a content determination process executed by the management device 39. In FIG. 7, an image is set as the content that the notification device 44 is caused to display. The present process is implemented by the notification transmitting unit 47G when it is determined at S22 whether or not the user sensing unit 45 has sensed the user in the space in the exit room area 5. The content determination process may be implemented in parallel, separately from the exit setting process.

At S70, the notification transmitting unit 47G acquires a result of the determination by the boarding sensing unit 47B at S22. If the user has been sensed at S70, the present process proceeds to S72.

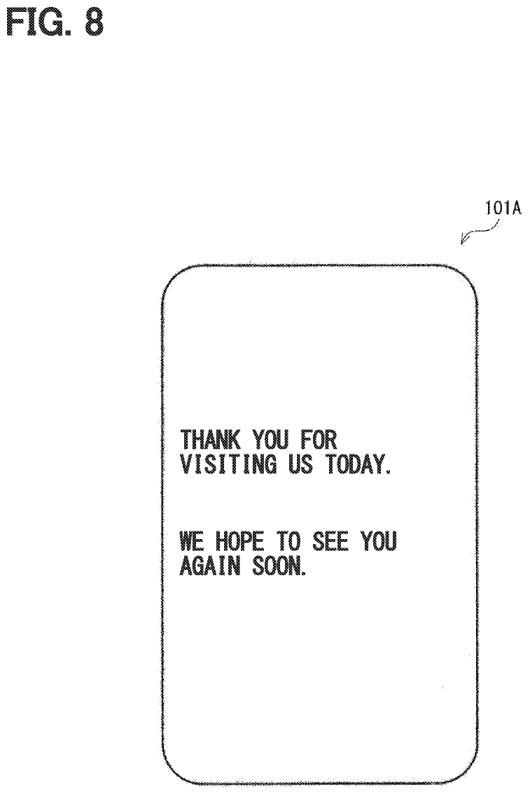

At S72, the notification transmitting unit 47G sets a see-off image 101A as an image that the notification device 44 is caused to display. The see-off image 101A is an example of the sensing content representing that the user has been sensed in the boarding area. For example, as illustrated in FIG. 8, the see-off image 101A displays a message expressing gratitude for a visit to the facility 22. After S72, the present process proceeds to S82. Data as a template of the content including the see-off image 101A is stored on the memory 53.

If the user has not been sensed at S70, the present process proceeds to S74. At S74, the notification transmitting unit 47G acquires a result of the determination by the time period determination unit 47E. If the current time is not in a time period during which there are usually many exits, the process proceeds to S78. If the current time is in a time period during which there are usually many exits, the process proceeds to S76.

At S76, the notification transmitting unit 47G acquires a result of the determination by the space determination unit 47D. If there is an available space in the exit room area 5, the present process proceeds to S78. If there are no available spaces in the exit room area 5, the process proceeds to S80.

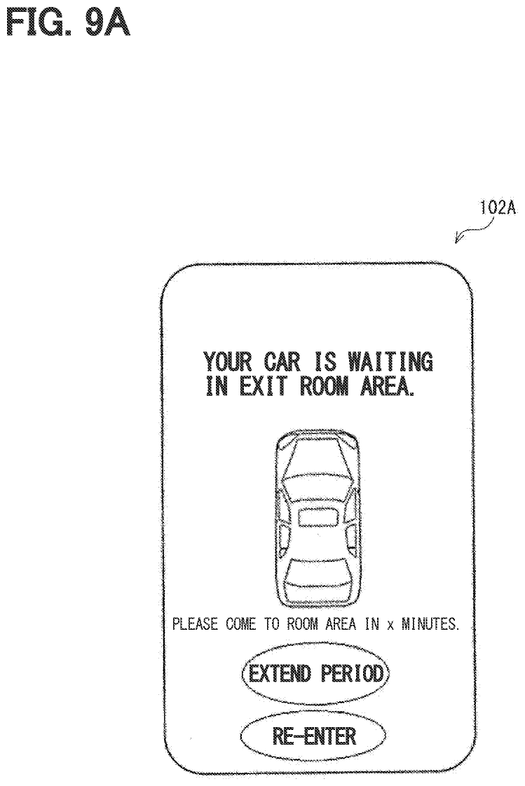

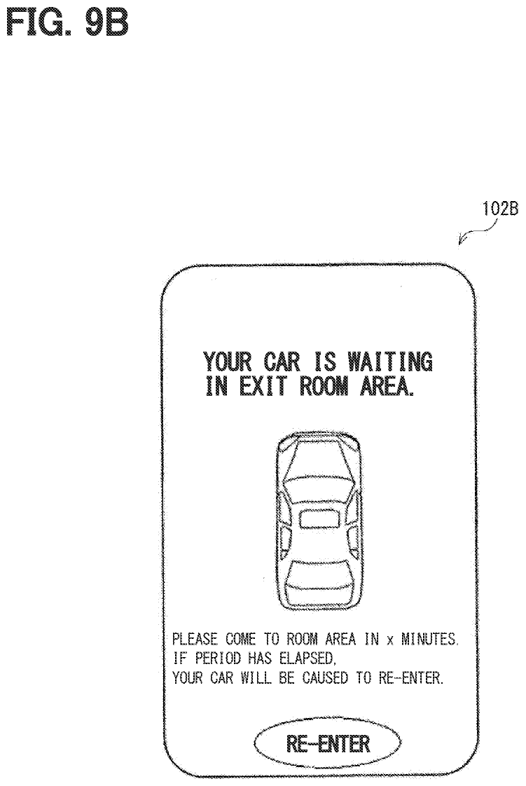

At S78, the notification transmitting unit 47G sets a first standby content as an image that the notification device 44 is caused to display. A first standby image 102A in FIG. 9A is an example of the first standby content including a request that the entrance guidance unit 47C be left unoperated. The first standby image 102A is displayed on the display of the notification device 44 if the user is not sensed, and also the user is allowed to extend the timer. In other words, the first standby image 102A is displayed on the display if the user is not sensed, and also the user is given a choice to leave the entrance guidance unit 47C unoperated.

The first standby image 102A displays a message that the self-driving vehicle 18 is waiting in the exit room area 5, a period left until the timer expires, an image for requesting to extend the timer, and an image for transmitting the re-parking request signal for the self-driving vehicle 18. For example, the image for requesting to extend the timer, and the image for transmitting the re-parking request signal for the self-driving vehicle 18 are displayed as button images. After the first standby content is set at S78, the process proceeds to S82.

If the user selects the image for requesting to extend the timer, the period during which the self-driving vehicle 18 waits in the exit room area 5 can be extended. Whether or not the user has selected the image for requesting to extend the timer is determined at S31.

If the user selects the image for transmitting the re-parking request signal, the notification device 44 outputs the re-parking request signal to the management device 39. At S25, the exit guidance unit 47A determines whether or not there is the re-parking request signal.

The extension of the timer may be limited to a predetermined number of times, for example once. The period extending unit 47F counts the number of times of extension about the self-driving vehicle 18, and stores the number of times of extension. If the number of times of extension becomes larger than the predetermined number of times, the display of the notification device 44 displays a second standby content mentioned later.

The number of times of extension does not have to be limited to a predetermined number of times. In this case, if the timer is extended, the first standby image 102A in FIG. 9A is displayed again.

If the user selects the image for requesting to extend the timer, another image for setting an extended period may be displayed. Instead of an extended period, a time may be set.

At S80, the notification transmitting unit 47G sets the second standby content as an image to be transmitted to the notification device 44. A second standby image 102B in FIG. 9B is an example of the second standby content not including a request that the entrance guidance unit 47C be left unoperated, but including a request that the self-driving vehicle 18 be guided to a parking position in the parking lot. The second standby image 102B is displayed on the display of the notification device 44 if the user is not sensed, and also the user is not allowed to extend the timer. In other words, the second standby image 102B is displayed on the display of the notification device 44 if the user is not sensed, and also the user is not given a choice to leave the entrance guidance unit 47C unoperated. The second standby image 102B displays a message that the self-driving vehicle 18 is waiting in the exit room area 5, a period left until the timer expires, a message that the self-driving vehicle 18 is caused to re-enter the parking lot if the timer expires, and an image for transmitting the re-parking request signal for the self-driving vehicle 18. After the image is selected, the present process proceeds to S82.

At S82, a notification transmitting unit 47B transmits, to the notification device 44, a command for causing the notification device 44 to notify a set image. On the basis of the command for causing the notification device 44 to notify the set image, the notification device 44 displays the image on the display of the notification device 44. For example, the command for causing the notification device 44 to notify the set image may be an image generated by a notification device 47G or may be the generated image and a command for displaying the image.

By input manipulation on the notification device 44, the user can give an instruction for causing the self-driving vehicle 18 to re-enter. If it is determined that the user cannot return to the exit room area before the timer expires or if the action plan of the user has been changed, and the user does not have the intention to return to the exit room area, the image for transmitting the re-parking request signal for the self-driving vehicle 18 is selected. By re-parking the self-driving vehicle 18 without waiting for the expiration of the timer, it is possible to avoid a situation where the exit room area 5 is occupied.

If the user is sensed, the notification device 44 displays the see-off image 101A. According to such a configuration, by making the user feel that what the user had to do at the facility 22 has been completed, it can be expected that the user promptly starts travelling from the exit room area 5 to the exit.

According to the present disclosure, when the self-driving vehicle 18 has arrived at the boarding area due to operation of the exit guidance unit 47A, the self-driving vehicle 18 is in the boarding area during the threshold time period, and/or the user has been sensed by the boarding sensing unit 47B, the notification transmitting unit 47G may perform notification on the notification device 44 that is carried by the user, and can receive a request of the user as input.

In response to the arrival of the self-driving vehicle 18 at the boarding area, the notification transmitting unit 47G may transmit a command for causing the notification device 44 to notify the exit notification content representing that the self-driving vehicle 18 has arrived at the boarding area.

In response to sensing of the user by the boarding sensing unit, the notification transmitting unit 47G may transmit a command for causing the notification device 44 to notify the sensing content representing that the user has been sensed in the boarding area.

The parking assist device 1 may include the period extending unit 47F that extends the threshold time period after receiving, from the notification device 44, a request that the entrance guidance unit 47C be left unoperated.

If the user is not sensed by the boarding sensing unit 47B, and also the user is given a choice to leave the entrance guidance unit 47C unoperated, the notification transmitting unit 47G may transmit a command for causing the notification device 44 to notify the first standby content including a request that the entrance guidance unit 47C be left unoperated.

If the user is not sensed by the boarding sensing unit 47B, and also the user is not given a choice to leave the entrance guidance unit 47C unoperated, the notification transmitting unit 47G may transmit, to the notification device 44, the second standby content not including a request that the entrance guidance unit 47C be left unoperated, but including a request that the self-driving vehicle 18 be guided to a second target position.

According to this configuration, even if the user is not in or around the exit room area 5, the user can grasp whether or not the self-driving vehicle 18 has arrived the exit room area. Depending on whether or not the user is allowed to input extension of the timer, the first standby content or the second standby content is set. It is possible to avoid a circumstance where the timer cannot be extended despite the fact that the user has performed input manipulation for an extension request.

If the user is about to board the self-driving vehicle 18, the user who has arrived at the exit room area 5 can promptly board the self-driving vehicle 18 by extending the timer. For other users, because the number of times of extension of the timer is limited, it is possible to avoid a situation where the exit room area 5 is occupied for a predetermined period or longer.

[1-2-2. Self-Driving Exit Process Executed by Self-Driving Vehicle 18]

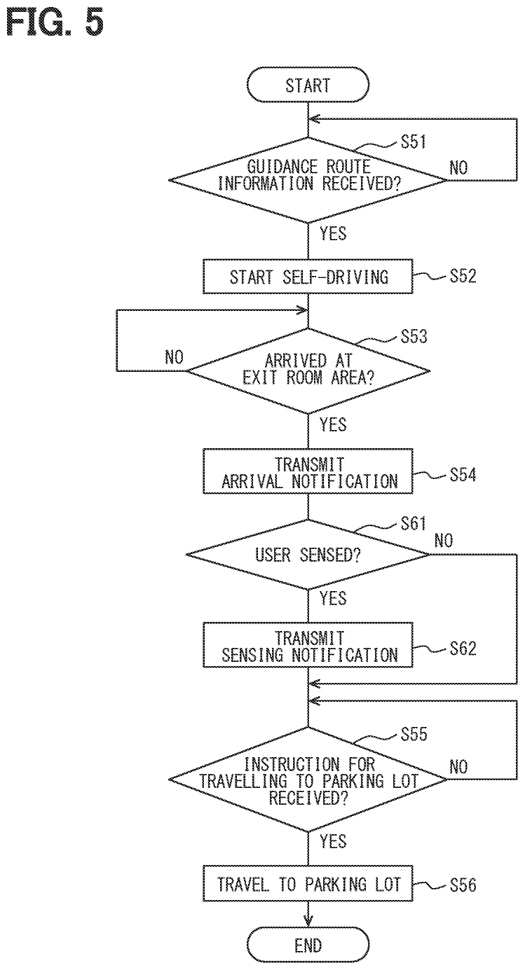

A self-driving exit process executed by a self-driving vehicle 18 is explained on the basis of FIG. 5. The self-driving exit process is a process of causing a self-driving vehicle 18 to move unaided from a parking position to the exit room area 5 in accordance with the exit setting process executed by the management device 39. In the self-driving exit process, depending on a situation that follows, the self-driving vehicle 18 implements a process of performing unaided movement from the exit room area 5 to a parking position in some cases.

As illustrated in FIG. 5, in the self-driving exit process, at S51, the control unit 69 of the self-driving vehicle 18 determines whether or not a communication unit 67 has received guidance route information. Guidance route information is transmitted by the management device 39. If guidance route information has been received, the present process procedure proceeds to S52. If guidance route information has not been received, the present process repeats S51.

At S52, the control unit 69 starts self-driving. When performing the self-driving, the control unit 69 causes the self-driving vehicle 18 to travel on the basis of the guidance route information. The self-driving vehicle 18 is caused to travel due to the self-driving.

Subsequently, at S53, the control unit 69 determines whether or not the self-driving vehicle 18 has arrived at the exit room area 5, which is the target position. If the self-driving vehicle 18 has arrived at the exit room area 5, the present process proceeds to S54. If the self-driving vehicle 18 has not arrived at the exit room area 5, the present process repeats S53.

Subsequently, at S54, the control unit 69 transmits an arrival notification by using the communication unit 67. The management device 39 receives the transmitted arrival notification.

Subsequently, at S61, the control unit 69 determines whether or not the user has been sensed at the self-driving vehicle 18. Here, it is determined that the user has been sensed if the door lock of the self-driving vehicle 18 is opened, a power supply such as the ignition of the self-driving vehicle 18 is manipulated, radio waves from a remote control key of the self-driving vehicle 18 have been sensed, and so on.

If the user has been sensed, at S62, the control unit 69 transmits a sensing notification to the management device 39. The management device 39 receives the sensing notification, and determines that the user has been sensed. If the user has not been sensed, the present process proceeds to S55.

Subsequently, at S55, the control unit 69 determines whether or not an instruction for travelling to the parking lot 7 has been received. The instruction for travelling to the parking lot 7 is transmitted at the management device 39. If an instruction for travelling to the parking lot 7 has not been received, the present process repeats the process at S55.

If an instruction for travelling to the parking lot 7 has been received, at S56, the control unit 69 causes the self-driving vehicle 18 to self-travel in accordance with the guidance route included in the travel instruction. If this process ends, the present process ends.

[1-3. Advantageous Effects]

According to the embodiment mentioned in detail above, the following advantageous effects can be attained.

(1a) One aspect of the present disclosure is the management device 39 configured to assist vehicles to park. Self-driving vehicles 18 are vehicles configured to be capable of implementing self-driving to target positions set by the management device 39 in the parking lot.

The management device 39 includes the exit guidance unit 47A, the boarding sensing unit 47B, and the entrance guidance unit 47C. The exit guidance unit 47A is configured to guide a self-driving vehicle 18 to the first target position on the basis of the intention of the user to exit, the first target position being the boarding area in the parking lot.

For example, the boarding sensing unit 47B is configured to sense the intention of the user to board the self-driving vehicle 18 at a certain timing such as a timing after the self-driving vehicle 18 has arrived at the boarding area due to operation of the exit guidance unit 47A or always continuously. The intention to board is different from the intention of the user to exit, and these intentions are different intentions. The entrance guidance unit 47C is configured to guide the self-driving vehicle 18 to the second target position if the boarding sensing unit 47B does not sense the intention to board within the threshold time period set in advance after the self-driving vehicle 18 has arrived at the boarding area due to operation of the exit guidance unit 47A, the second target position being a parking position in the parking lot.

According to such a configuration, because the self-driving vehicle 18 is moved to the parking position when the threshold time period has elapsed after the self-driving vehicle 18 has arrived at the boarding area, it is possible to reduce the likelihood that the self-driving vehicle 18 occupies the boarding area for a long time. It is possible to reduce the likelihood that the self-driving vehicle 18 is moved when the user has approached the self-driving vehicle 18 within the threshold time period. Therefore, it is possible to reduce the likelihood that the self-driving vehicle 18 waiting for the user hinders another vehicle exiting the parking area while the convenience of the user is ensured.

(1b) In one aspect of the present disclosure, the boarding area includes a plurality of spaces. The space determination unit 47D is configured to determine whether or not there is an available space where there is not a vehicle in the boarding area. The entrance guidance unit 47C is configured to not guide the self-driving vehicle 18 to a parking position if there is an available space. The entrance guidance unit 47C is configured to keep the self-driving vehicle 18 parked in a parking space if it is determined that there is an available space.

According to such a configuration, it is possible to realize a configuration in which the self-driving vehicle 18 is permitted to occupy a space in the boarding area if there is an available space in the boarding area. Therefore, the convenience of the user can be enhanced. Because the self-driving vehicle 18 stays in the boarding area even after the timer has expired if there is an available space in the boarding area, unaided movement of the self-driving vehicle 18 can be reduced, and fuel consumption or battery power consumption can be reduced. By not causing the self-driving vehicle 18 to re-enter the parking lot 7, the number of available spaces in the parking lot 7 that are available for self-driving vehicles of other users increases, and also the number of choices regarding guidance routes increases; as a result, the convenience of the other users is enhanced.

(1c) In one aspect of the present disclosure, the time period determination unit 47E is configured to determine whether or not the current time is in a congestion time period set in advance as a time period during which the boarding area usually becomes congested. The entrance guidance unit 47C is configured to not guide the self-driving vehicle 18 to a parking position if the current time is not in a congestion time period. The entrance guidance unit 47C is configured to keep the self-driving vehicle 18 parked in a parking space if the current time is in a normal time period.

According to such a configuration, because it is possible to determine whether or not the boarding area will be congested depending on the time period, it is possible to determine whether to or not to cause the self-driving vehicle 18 to re-enter with a simple configuration. Furthermore, as mentioned above, advantageous effects due to reduction of unaided movement of the self-driving vehicle 18 can be attained.

(1d-1) In one aspect of the present disclosure, the period extending unit 47F is configured to extend the threshold time period if a request that the entrance guidance unit 47C be not operated is received from the terminal device 43 configured to be capable of receiving a request from the user as input.

(1d-2) The period extending unit 47F may be configured to extend the threshold time period if a request that the entrance guidance unit 47C be not operated, in other words, a request that the entrance guidance unit 47C be left unoperated is received from the notification device 44.

(1d-3) According to the configurations of (1d-1) and (1d-2) described above, because the threshold time period can be extended in accordance with a request of the user, it is possible to reduce the likelihood that the self-driving vehicle 18 is caused to re-enter for a while if there is a request from the user. Furthermore, as mentioned above, advantageous effects due to reduction of unaided movement of the self-driving vehicle 18 can be attained.

(1e) In one aspect of the present disclosure, the notification transmitting unit 47G is configured to perform notification on the notification device 44 carried by the user when the self-driving vehicle 18 has arrived at the boarding area due to operation of the exit guidance unit 47A, and/or the entrance guidance unit 47C is operated.

According to such a configuration, it is possible to notify the user of the position of the self-driving vehicle 18, and the movement situation of the self-driving vehicle 18 by using the notification device 44.

(1f) In one aspect of the present disclosure, the boarding area includes a plurality of spaces including a parking space where the self-driving vehicle 18 has arrived, and the boarding sensing unit 47B is configured to activate the timer in response to the arrival of the self-driving vehicle 18 at the parking space, and determine that the intention to board is not sensed if a period measured by the timer has become longer than the threshold time period.

According to such a configuration, it is possible to determine that there is not the intention to board in accordance with whether or not the period measured by the timer has become longer than the threshold time period.

(1g) In one aspect of the present disclosure, the boarding sensing unit 47B is configured to determine whether or not the shutter of the boarding area is opened as the intention to board the self-driving vehicle 18, and sense that there is the intention of the user to board the self-driving vehicle 18 if the shutter is opened.

According to such a configuration, it is possible to determine whether or not there is the intention to board in accordance with whether or not the shutter is open.

(1h) In one aspect of the present disclosure, the boarding sensing unit 47B is configured to receive a sensing notification transmitted from the self-driving vehicle 18 as the intention to board the self-driving vehicle 18, and is configured to sense that there is the intention of the user to board the self-driving vehicle 18 if the sensing notification is received.

According to such a configuration, it is possible to determine whether or not there is the intention to board in accordance with whether or not the sensing notification transmitted from the self-driving vehicle 18 has been transmitted.

(1i) In one aspect of the present disclosure, the notification transmitting unit 47G is configured to perform notification on the notification device 44 that is carried by the user, and configured to be capable of receiving a request as input when the self-driving vehicle 18 has arrived at the boarding area due to operation of the exit guidance unit 47A, the self-driving vehicle 18 is in the boarding area, and/or the user has been sensed by the boarding sensing unit 47B.

According to such a configuration, it is possible to perform notification on the notification device 44 when the user can board the self-driving vehicle 18, and so on.

(1j) In one aspect of the present disclosure, the notification transmitting unit 47G is configured to transmit a command for causing the notification device 44 to notify the exit notification content representing that the self-driving vehicle 18 has arrived at the boarding area, in response to the arrival of the self-driving vehicle 18 at the boarding area. According to such a configuration, it is possible to use the exit notification content to notify the user that the user can board a self-driving vehicle 1818.

(1k) In one aspect of the present disclosure, the notification transmitting unit 47G is configured to transmit a command for causing the notification device 44 to notify the sensing content representing that the user has been sensed in the boarding area, in response to the sensing of the user by the boarding sensing unit 47B.

According to such a configuration, it is possible to use the sensing content to notify the user that the user has been sensed.

(1l) In one aspect of the present disclosure, the notification transmitting unit 47G is configured to transmit a command for causing the notification device 44 to notify the first standby content including a request that the entrance guidance unit 47C be left unoperated if the user is not sensed by the boarding sensing unit 47B, and also the user is given a choice to leave the entrance guidance unit 47C unoperated.

According to such a configuration, because it is possible to notify the first standby content including the request that the entrance guidance unit 47C be left unoperated, it is possible to perform setting in according with the intention of the user such that the self-driving vehicle 1818 is not caused to re-enter.

(1m) In one aspect of the present disclosure, the notification transmitting unit 47G is configured to transmit a command for causing the notification device 44 to notify the second standby content not including a request that the entrance guidance unit 47C be unoperated, but including a request that the self-driving vehicle 18 be guided to the second target position if the user is not sensed by the boarding sensing unit 47B, and also the user is not given a choice to leave the entrance guidance unit 47C unoperated.

According to such a configuration, it is possible to transmit the second standby content including the request that the self-driving vehicle 18 be guided to the second target position.

### 2. OTHER EMBODIMENTS

Whereas an embodiment of the present disclosure has been explained thus far, the present disclosure is not limited to the embodiment mentioned before, but can be implemented by being modified variously.

(2a) Whereas the user sensing unit 45 is configured as a shutter in the embodiment described above, this is not the sole example. For example, the user sensing unit 45 may be a configuration for sensing a user approaching a self-driving vehicle 18 by using a heat sensor, or the like. Whereas a self-driving vehicle 18 includes a configuration for sensing the status of the door lock of the self-driving vehicle 18, a configuration for sensing the status of a power supply such as the ignition of the self-driving vehicle 18, and the like in the embodiment described above, the user sensing unit 45 may sense them.

The user sensing unit 45 may be configured as a camera that is installed in the exit room area 5, and captures images of the inside of the exit room area 5. In this case, the user sensing unit 45 analyzes the camera images, and determines whether or not there is a user in the exit room area 5. If the user is captured in a camera image, it may be determined that the user has been sensed.

The boarding sensing unit 47B may use position information obtained by a GPS functionality of a wireless terminal device such as a portable phone or a smartphone carried by a user. In this case, on the basis of the position information received from the wireless terminal device, the boarding sensing unit 47B may determine whether the wireless terminal device is in a predetermined area around the entrance 23 of the facility 22. If it is determined that the wireless terminal device is in the predetermined area, it may be determined that the user has been sensed.

The intention of a user to exit may be represented by input manipulation on a wireless terminal device such as a portable phone or a smartphone carried by the user. That is, after the notification device 44 outputs an image and a sound according to an exit notification (S14), an image on which the user can input information representing whether or not the user is planning to board a self-driving vehicle 18 or the user can make selection whether to or not to board the self-driving vehicle 18 may be displayed the screen of the notification device 44.

According to the configuration described above also, it is possible to determine whether or not there is the intention of the user to board the self-driving vehicle 18.

(2b) A plurality of functionalities that one constituent element in the embodiments described above has may be realized by a plurality of constituent elements, one functionality that one constituent element has may be realized by a plurality of constituent elements, and so on. A plurality of functionalities that a plurality of constituent elements have may be realized by one constituent element, one functionality that is realized by a plurality of constituent elements may be realized by one constituent element, and so on. Some of the configurations of the embodiments described above may be omitted. At least some of the configurations of the embodiments described above may be added to or replace the configurations of another embodiment described above.

(2c) Other than the management device 39 mentioned before, the present disclosure can also be realized in various forms such as the parking assistance system 1 having the management device 39 as a constituent element, a program for causing a computer to function as the management device 39, a non-transitory tangible recording medium such as a semiconductor memory having the program recorded thereon or a parking assistance method.

What is claimed is:

1. A parking assist device configured to assist a user to park a self-driving vehicle, the parking assist device comprising:
an exit guidance unit that is configured to guide, to a boarding area as a first target position in a parking lot, the self-driving vehicle capable of performing self-driving based on a user's intention to exit;
a boarding sensing unit that is configured to sense an intention of the user to board the self-driving vehicle;
an entrance guidance unit that is configured to guide the self-driving vehicle to a parking positon as a second target position in the parking lot when a predetermined threshold time period has elapsed without sensing the intention of the user to board by the boarding sensing unit after the self-driving vehicle operated by the exit guidance unit arrived at the boarding area; and
a time period determination unit that is configured to determine whether a current time is within a predetermined congestion time period that is set as a time period during which the boarding area tends to be congested, wherein
the entrance guidance unit is further configured not to guide the self-driving vehicle to the second target position when the time period determination unit determines that the current time is not within the congestion time period.

2. The parking assist device according to claim 1, wherein
the boarding area includes a plurality of spaces,
the parking assist device further comprises a space determination unit that is configured to determine whether an available space exists in the boarding area, and
the entrance guidance unit is configured not to guide the self-driving vehicle to the second target position when the available space exists.

3. The parking assist device according to claim 1, further comprising
a notification transmitting unit that is configured to transmit a notification to a notification device owned by the user when the self-driving vehicle operated by the exit guidance unit arrives at the boarding area, wherein
the notification transmitting unit is further configured to transmit a command for the notification device to display an exit notification content indicating that the self-driving vehicle arrives at the boarding area, and
the exit notification content includes an image of the self-driving vehicle and a message indicative of arrival of the self-driving vehicle at an exist room area.

4. The parking assist device according to claim 1, further comprising
a period extending unit that is configured to extend the threshold time period when receiving a request not to operate the entrance guidance unit from a terminal device used by the user for input.

5. The parking assist device according to claim 1, further comprising
a notification transmitting unit that is configured to give a notification to a notification device owned by the user when the self-driving vehicle operated by the exit guidance unit arrives at the boarding area or when the entrance guidance unit is operated.

6. The parking assist device according to claim 1, wherein
the boarding area includes a plurality of spaces,
the parking space where the self-driving vehicle arrived is one of the plurality of spaces,
the boarding sensing unit is configured to activate a timer in response to the self-driving vehicle arriving at the parking space, and
the boarding sensing unit is configured to determine that the intention to board is not sensed when a period measured by the timer exceeds the threshold time period.

7. The parking assist device according to claim 6, further comprising
a space determination unit that is configured to determine whether an available space other than the parking space exists in the boarding area, wherein
the entrance guidance unit is configured to keep the self-driving vehicle parked in the parking space when the space determination unit determines that the available space exists.

8. The parking assist device according to claim 6, further comprising
a time period determination unit that is configured to determine whether a current time is within a predetermined congestion time period set as a time period during which the boarding area tends to be congested or within a normal time period other than the congestion time period, wherein
the entrance guidance unit is configured to keep the self-driving vehicle parked in the parking space when the time period determination unit determines that the current time is within the normal time period.

9. The parking assist device according to claim 6, wherein
the boarding sensing unit is configured to determine, as the intention to board the self-driving vehicle, whether a shutter of the boarding area is open, and
the boarding sensing unit is configured to sense that the user has the intention to board the self-driving vehicle upon determining that the shutter is open.

10. The parking assist device according to claim 6, wherein
the boarding sensing unit is configured to receive, as the intention to board the self-driving vehicle, a sensing notification transmitted from the self-driving vehicle, and
the boarding sensing unit is configured to sense that the user has the intention to board the self-driving vehicle upon receiving the sensing notification.

11. The parking assist device according to claim 1, further comprising
a notification transmitting unit that is configured to transmit a notification to a notification device owned by the user for input when the self-driving vehicle operated by the exit guidance unit arrives at the boarding area, when the self-driving vehicle is in the boarding area, or when the user is sensed by the boarding sensing unit.

12. The parking assist device according to claim 11, wherein
the notification transmitting unit is configured to transmit, in response to the self-driving vehicle arriving at the boarding area, a command for the notification device to display an exit notification content indicating that the self-driving vehicle arrives at the boarding area.

13. The parking assist device according to claim 11, wherein
the notification transmitting unit is configured to transmit, in response to the boarding sensing unit sensing the user, a command for the notification device to display a sensing content indicating that the user is sensed at the boarding area.

14. The parking assist device according to claim 11, further comprising
a period extending unit that is configured to extend the threshold time period upon receiving, from the notification device, a request not to activate the entrance guidance unit.

15. The parking assist device according to claim 14, wherein
the notification transmitting unit is configured to transmit a command for the notification device to display a first standby content including a request not to activate the entrance guidance unit when the user is not sensed by the boarding sensing unit and when the user is given a choice not to activate the entrance guidance unit.

16. The parking assist device according to claim 14, wherein
the notification transmitting unit is configured to transmit a command for the notification device to display a second standby content not including a request not to activate the entrance guidance unit but including a request to guide the self-driving vehicle to the second target position when the user is not sensed by the boarding sensing unit and when the user is not given a choice not to activate the entrance guidance unit.

17. A parking assist device configured to assist a user to park a self-driving vehicle, the parking assist device comprising
at least one processor that is configured to:
guide, to a boarding area as a first target position in a parking lot, the self-driving vehicle capable of performing self-driving based on a user's intention to exit;
sense an intention of the user to board the self-driving vehicle;
guide the self-driving vehicle to a parking positon as a second target position in the parking lot when a predetermined threshold time period has elapsed without sensing the intention of the user to board after the self-driving vehicle operated by the exit guidance unit arrived at the boarding area; and
determine whether a current time is within a predetermined congestion time period that is set as a time period during which the boarding area tends to be congested, wherein
the processor is further configured not to guide the self-driving vehicle to the second target position upon determining that the current time is not within the congestion time period.
